(19) United States
(12) Patent Application Publication
(10) Pub. No.: US 2010/0172477 A1
(43) Pub. Date: Jul. 8, 2010

(54) ELECTRICAL WHEEL LOCK SYSTEM AND METHOD

(76) Inventors: Michael Kusner, Perrysburg, OH (US); Dejan Teofilovic, Ann Arbor, MI (US); William van Kampen, Saline, MI (US)

Correspondence Address: BRINKS HOFER GILSON & LIONE, P.O. BOX 10395, CHICAGO, IL, 60610, US

(21) Appl. No.: 12/349,884

(22) Filed: Jan. 7, 2009

(51) Int. Cl. H05G 1/02

(52) U.S. Cl. 378/198; 16/35 R

(57) ABSTRACT

A system for performing medical imaging in a mobile environment. The system includes a sensing array, a controller, and a mobile frame. The sensing array is configured to image a subject. The controller is in communication with the sensing array to control and process the acquisition performed by the sensing array. The sensing array is attached to the mobile frame, and the mobile frame includes wheels to facilitate movement of the system. At least one of the wheels of the base interacts with a wheel lock, such that the wheel lock prevents motion of the wheel when activated by the controller.

### BACKGROUND

1. Field of the Invention

The present invention generally relates to a system and method for locking the wheels of a portable medical imaging device.

2. Description of Related Art

In a typical x-ray computed tomography system, an x-ray source projects an x-ray beam through an object and onto a detector. However, more recently portable computed tomography systems have been introduced into the market. These systems generally include an x-ray source, a detector, and a gantry system mounted to a movable base. The base may include wheels allowing the system to be taken into the room of the patient rather than moving the patient to the computed tomography system. This can reduce the possibility of injury to the patient and allow for better utilization of hospital space. While the mobility of a portable computed tomography system is very desirable, computed tomography systems take many scans of a patient at a number of angles. As such, the gantry must move, for example rotate around the patient, during the measurement scan. However, any change in the position of the system relative to the patient may introduce significant error and reduce the resolution of the measurements made by the computed tomography system. Therefore, it is important to maintain a fixed relationship between the base and the patient during scanning.

In view of the above, it is apparent that there exists a need for a system and method for locking the wheels of a portable medical imaging device.

### SUMMARY

In overcoming the drawbacks and other limitations of the related art, the present invention provides a system and method for locking the wheels of a portable medical imaging device.

The system includes a sensing array, a controller, and a mobile base. The sensing array is configured to image a subject. A controller is in communication with the sensing array to control and process the acquisition performed by the sensing array. The sensing array is attached to the mobile base and the mobile base includes wheels to facilitate movement of the system. At least one of the wheels of the base interacts with a wheel lock, such that the wheel lock prevents motion of the wheel when activated by the controller.

In another aspect of the system, the wheel lock may prevent the wheel from rolling, swiveling, or both. In addition, the system may alert the user if the wheel lock is faulty. The controller may also prevent acquisition by the sensing array or suppress motion by a motion device if the wheel is not locked.

In another aspect of the system, the system defaults to a transportation mode where at least one wheel is swivel locked when the system is powered off.

In another aspect of the system, the system defaults to a free motion mode where each of the wheel locks is deactivated when the system is powered on or an alignment tool is activated.

In yet another aspect of the system, the system defaults to a free motion mode where each of the wheel locks is deactivated when an emergency stop control is activated allowing the operator to quickly move the system away from the subject.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for performing computed tomography;

FIG. 2 is a perspective view of an x-ray source and detector;

FIG. 3 is a perspective view of x-ray paths projected through a voxel;

FIG. 4 is a perspective view of x-ray paths and combinations of voxels through which the x-ray paths pass;

FIG. 5 is a schematic view of a system for controlling wheel lock mechanisms;

FIG. 6 is a perspective view of a motor assembly for locking wheels; and

FIG. 7 is a flowchart illustrating a method for controlling wheel lock mechanisms.

### DETAILED DESCRIPTION

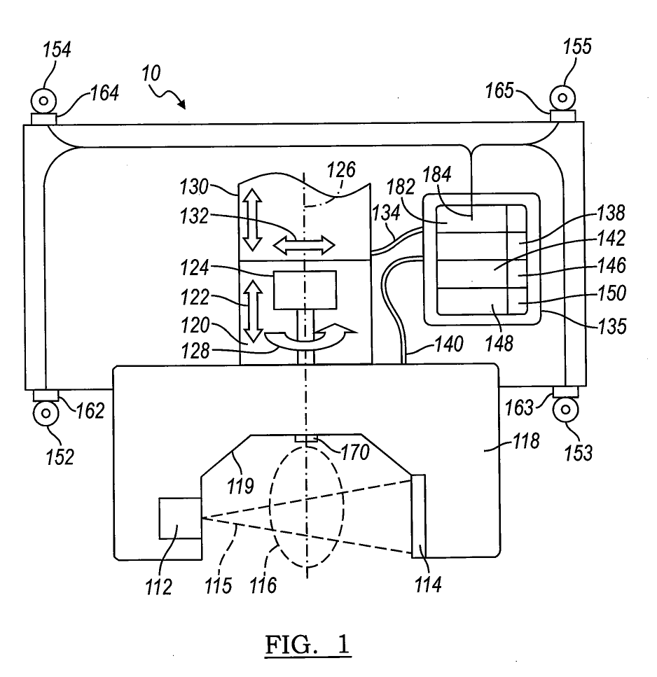

FIG. 1 illustrates a portable flat panel x-ray tomography system 10 embodying the principles of the present invention. The system 10 includes an x-ray source 112 and a detector 114. The x-ray source 112 projects x-rays, denoted by reference number 115 through an object 116 and toward the detector 114. The detector 114, may be a two-dimensional detector array, such as an amorphous silicon flat panel (coupled with a scintillation crystal), a traditional multi row computed tomography detector, or other similar imaging detectors. The object 116 may for example, be the head of a patient and the system 110 may be configured to image a sinus cavity within the patient. The x-ray source 112 and the detector 114 may be mounted to a structure 118. The structure 118 maintains the position and orientation of the x-ray source 112 with respect to the detector 114. The structure 118 includes a recess 119 that allows various objects, for example, a patient's head to be located between the x-ray source 112 and the detector 114.

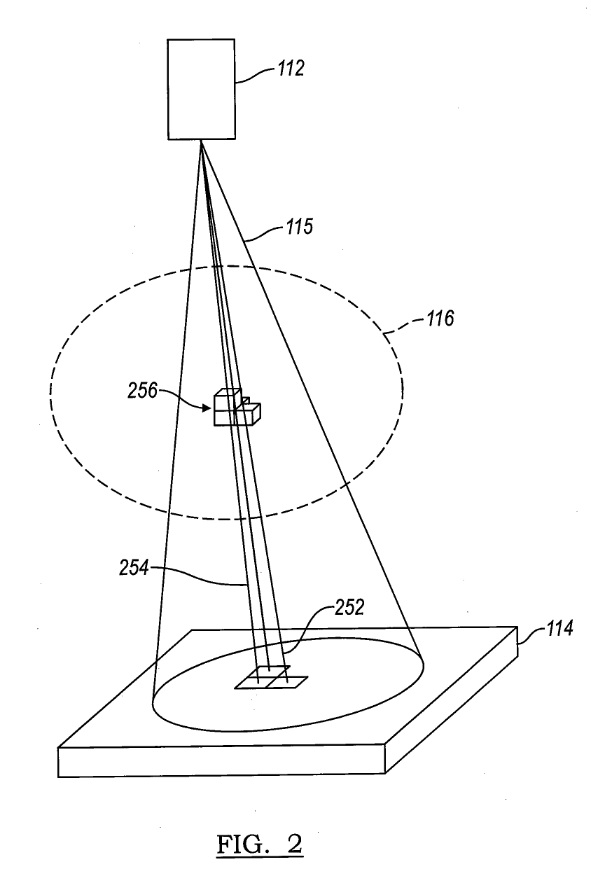

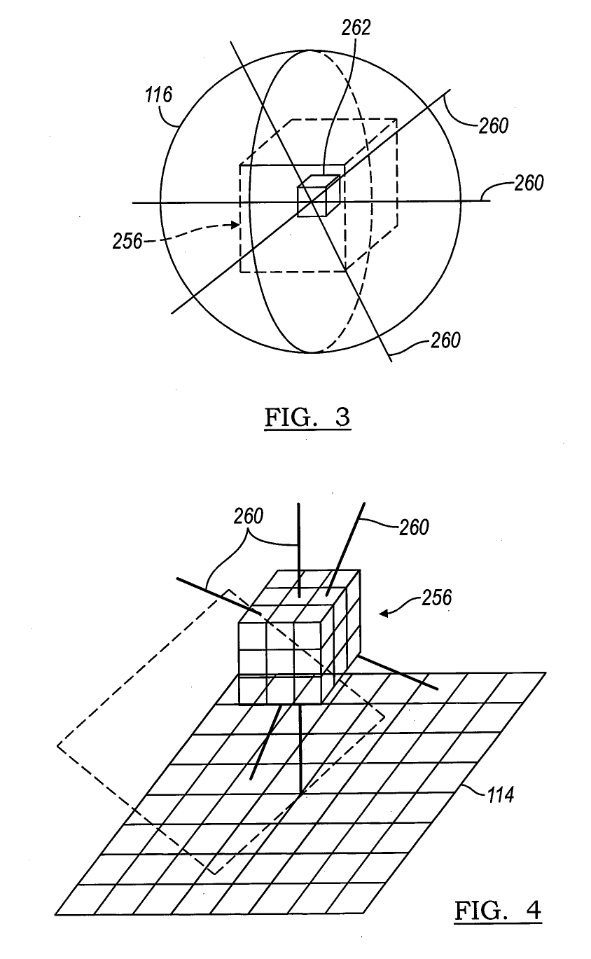

The structure 118 is connected to a number of motion control devices configured to manipulate the position of the x-ray source 112 and detector 114 relative to the object 116 during scanning. The x-ray beam is projected along each path to the detector 114. Each path generates a different intensity on the detector 114 based on the density of the object along that path, as shown in FIG. 2. As such, the intensity at each pixel 252 in the detector 114 corresponds to an accumulated density at each point along the line representing the x-ray path 254. Therefore, it is helpful to represent the object 116 as a model that is made up of small cube-type elements called voxels 256. The intensity seen at the two-dimensional detector 114 is a function of the density accumulation through each voxel 256 that the x-ray path 254 travels through. To calculate the density at a particular voxel 262, a number of x-ray path lines 260 through each voxel 256 may be utilized to isolate the density contribution for that particular voxel 262 as shown in FIG. 3 and FIG. 4. This serves as the basis for various computed tomography systems and many methods and adaptations are well known in the art. Since a computed tomography image is constructed based on many scans in various poses, the reference for each pose must be consistent. As such, it is important to maintain a known relationship between the system and the object being scanned. As such the system should closely track planned motion and constrain unwanted motion between the object and the system.

Being a portable system, the system 10 includes wheels 152, 153, 154, and 155. To allow easy motion of the system 10, the wheels are generally allowed to swivel as well as roll. For the purposes of this application, wheel rolling is generally considered rotation about a central axis of the wheel that is substantially parallel to the outer surface of the wheel that contacts the ground. Swiveling is generally considered rotation of the wheel about an axis that is substantially perpendicular to the central axis of the wheel and the ground. To provide maximum portability, each wheel 152-155 may be allowed to freely roll and swivel. However, it is contemplated herein that each or any combination of the wheels may be controlled to allow or prevent rolling and/or swiveling selectively based on the mode of the system.

While the wheels 152-155 are important for the portability of the system 10, it is equally important to constrain undesired motion of the system 10 during scanning. As such, the system 10 includes wheel locking mechanisms 162, 163, 164, 165. As discussed above, each wheel locking mechanism 162-165 may selectively prevent rolling, swiveling, or both swiveling and rolling for its corresponding wheel 152-162. For example, a control such as a button on the machine or a selection on a graphical user interface may be activated to initiate scanning of the object. Accordingly, the system 10 may be configured to automatically actuate one or more of the locking mechanisms 162-165 to prevent rolling and/or swiveling of the corresponding wheels 152-155. The locking of rolling and swiveling of the wheels may be optimal during scanning. Although, locking either rolling or swiveling of a subset of the wheels may be sufficient for maintaining the relationship between the system 10 and object 116 in a more cost-effective manner.

For example, two of the wheels in opposite corners of the system 10 may be locked to prevent undesired system movement. In one implementation, the front right wheel 152 may be swivel locked while the rear left wheel 155 may be full (rotation and swivel) locked. As such, translation of the system 10 is constrained by the full locking of the rear left wheel 155, and rotation of the system 10 about the rear left wheel 155 is prevented by the swivel locking of the front right wheel 152. Similarly, both the front right wheel 152 and the rear left wheel 155 may be full (rotation and swivel) locked to fully constrain motion of the system. In this case, the front left wheel 153 may be swivel locked during transportation of the system.

Generally, the front of the system 10 is defined by the recess 119 for receiving the object 116. As such, wheels 152 and 153 are generally defined as front wheels and wheels 154 and 155 are generally defined as rear wheels. Accordingly, wheels 152 and 154 are designated as right wheels, while wheels 153 and 155 are designated as left wheels.

In addition, other combinations of wheel locking may be implemented based on the current mode of use of the system 10. For example, in a transportation mode, one or more of the wheels may be swivel locked while all the wheels are allowed to roll freely. In one example, the front left wheel 153 may be swivel locked.

In another example, the rear left wheel 155 and optionally the rear right wheel 154 may be swivel locked to aid in steering the system 10 as it is transported from room to room. In this scenario, the system will have the feel of a shopping cart where the system 10 is not allowed spin freely about any axis. Rotation is allowed only about a certain wheel base defined by the swivel locked wheel(s). The system 10 may be designed to default to the transportation mode when the system power is off, as the system will typically be shut down and unplugged prior to transportation.

In alignment mode, the system 10 may allow all wheels to rotate and swivel freely. Allowing full flexibility when aligning the system, provides the flexibility to adjust the translation and rotation of the system without constraints. The system 10 may automatically enter the alignment mode upon power up of the system. As the system 10 will likely be in the proximity of the patient when it is plugged in and/or powered on. From that position, the free rotation and swivel flexibility can be used to translate or rotate the system 10 aligning it with the object 16 to be scanned.

In another embodiment, the system 10 may include an alignment tool 170. The alignment tool 170 may, for example include a laser projector indicating the optimal position of the object 16 relative to the system 10. As such, the system 10 may be configured to automatically enter the alignment mode upon activation of the alignment tool 170. Accordingly, a control may be provided activate the alignment tool 170 and the control may be monitored for a change in state indicative of activating the alignment tool 170. Accordingly, the system 10 may enter the alignment mode and unlock all wheels upon sensing the change of state in the control. In another aspect of the invention, an emergency stop button may immediately change the state of the system to a free wheel mode allowing all wheels to roll and swivel freely. Based on this description one can recognize variations on the wheel locking modes discussed may be implemented without deviating from the scope of this application. As such, additional methods for utilizing the wheel locking mechanisms are provided later.

The motion control devices described above may manipulate the position and orientation of the structure 118, thus the x-ray source 112 and detector 114, with regard to the object 116. As such, the system may include a linear gantry 120 configured to translate the structure 118 longitudinally along an axis 126, as denoted by arrow 122. Similarly, a second gantry 130 may be configured to translate the structure 118 laterally with respect to the axis 126, as denoted by arrow 132. As such, gantry 120 and gantry 130 may be oriented with their axis of translation perpendicular to one another providing a simple two-dimensional translation function between the gantries 120, 130. Further, a rotational stage 124 may be provided and connected to the structure 118 through a shaft 125. As such, the rotational stage 124 may be configured to rotate the structure 118 about the axis 126, as denoted by arrow 128. In one example, the linear gantries 120 and 130 may be used for fine alignment of the source 112 and detector 114 relative to the object 116 prior to scanning.

The motion devices 120, 124, 130 are connected to a controller 135, as denoted by line 134. The connection may be through a cable or a wireless connection, or other standard means of system communication. The motion devices 120, 124, 130 are in communication with a motion control processor 136 of the controller 135. The motion control processor 136 generates electrical control signals to manipulate the motors of each of the motion control devices 120, 124, 130. Similarly, the wheel lock mechanisms 162, 163, 164 and 165 are in communication with an I/O processor 182 of the controller 135 to actuate or released the wheel lock mechanisms as described elsewhere in the specification. The I/O processor 182 may communicate via a simple digital or analog output, or alternatively may communicate with smarter wheel lock mechanisms via a serial communication link or similar connection.

In addition, the x-ray source 112 and the detector 114 are in communication with the controller 135, as denoted by line 140. As such, the detector 114 is in communication with an image acquisition and processing module 142. The image acquisition and processing module 142 receives data from the detector 114 and calculates the density for each voxel 256.

The density for each voxel 256 is calculated by storing the intensity projection for multiple x-ray path lines 260 through the object 116, as can be seen from FIG. 4. As described above, each x-ray path line 260 includes a different combination of voxels 254. The density of the object 116 within each voxel 256 may be isolated by solving each voxel's contribution to the accumulated density along each x-ray path line 260. Since the total density along each x-ray path 260 is known from the pixel intensity, the unknown voxel densities can be solved for utilizing the series of equations representing the voxel combinations along each x-ray path 260. In addition, the image processing module 142 may account for any difference in intensity response for each pixel 252 of the detector 114 in reconstructing each voxel 256 in the model. As such, the intensity profile or image for each position may be stored in memory 146. In addition, the memory 146 may also store the resulting density at each voxel and the relationship between each pixel on the detector 114. The relationship between the intensity response for each pixel on the detector 114 may be stored as parameters of an equation or in a look-up table format. Note that multiple x-ray paths are recorded at each position of the structure (i.e., one for each pixel on the detector).

In addition, the controller 135 may include a display and planning module 148 that determines the series of positions and orientations of the structure 118 that will be necessary for constructing the model of the object 116. Such position planning may be stored in the memory 150 and transferred to or accessed by memory 138 of the motion control module 136. In addition, the planning and display module 148 may access or transfer the voxel model information from memory 150 to memory 146 of the image processing module 142.

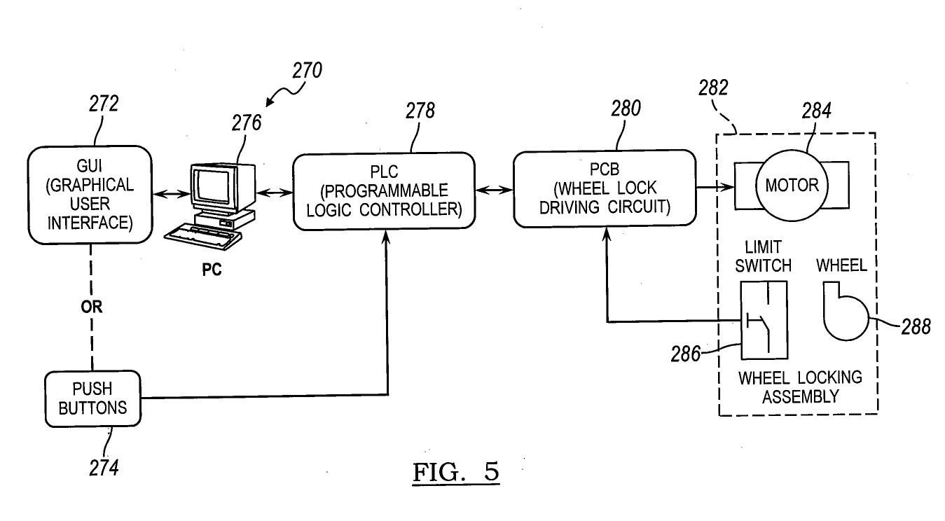

One embodiment of the system for locking one or more of the wheels of a medical imaging system is provided in FIG. 5 and as denoted by reference numeral 270. In one embodiment, locking of the wheels may occur automatically during initiation of a scan sequence. In other embodiments manipulation of the wheel locks can occur upon changing modes of the system between an acquisition mode, a transport mode, or a free motion mode. The modes may be changed through a graphical user interface denoted by reference number 272 or by a physical interface (i.e. buttons) as denoted by reference numeral 274. The graphical user interface 272 is generated and interpreted by a general purpose or industrial computer 276. The computer 276 may transmit commands received through the graphical user interface 272 to a programmable logic controller 278. In a similar manner, the programmable logic programmer 278 may receive commands from the physical interface 274 (i.e. buttons) directly through a PLC I/O interface. The programmable logic controller 278 is in communication with a circuit board 280 specially designed to interface with the wheel locking mechanisms. The interface board 280 receives power supply signals from the logic power supply and power supply signals from a motor power supply. The interface board 280 is in communication with a motor 284 in each wheel assembly 282. As described above, each wheel assembly may be swivel locked, rotation locked, or both. The motor 284 interfaces with a caster assembly 288 such that the motor 284 may rotate in one direction to swivel lock the caster assembly 288. Similarly, the motor 284 may rotate in a second direction to both swivel lock and roll lock the caster assembly 288. Alternatively, the motor 284 may move to in intermediate position such that the caster assembly 288 is neither swivel locked nor roll locked. In addition, the wheel assembly 282 includes a limit switch 286 that physically determines the position of the motor 284 and thereby the locking status of the corresponding caster assembly 288. The limit switch 286 may be a three position switch, thereby indicating if the wheel is in a full lock mode, a swivel lock mode, or a free motion mode.

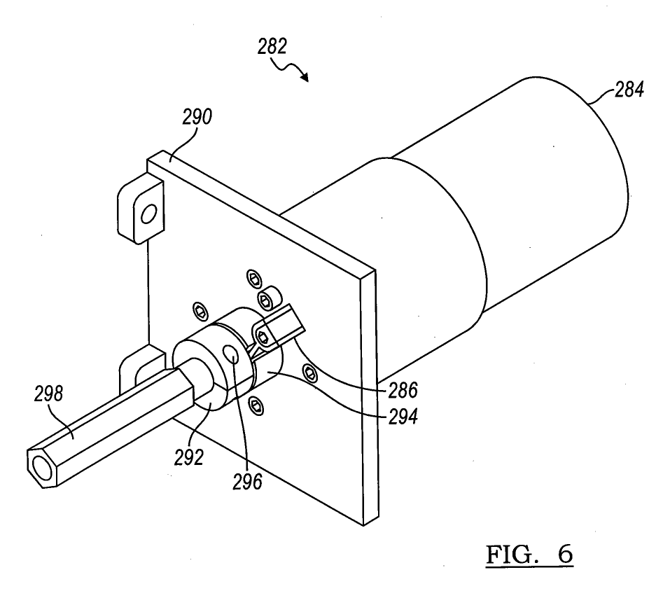

One specific embodiment of the wheel assembly 282 is shown in FIG. 6. The motor 284 is connected to a mounting plate 290 for example, using bolts. A sleeve 298 with a hexagonal end portion extends over the shaft of the motor 284. A first collar 292 is tightened over the sleeve 298 thereby attaching sleeve 298 to the shaft of the motor 284. In addition, the switch 286 is attached to the mounting plate 290 and interacts with a second collar 294 fastened over the sleeve 298 and configured to rotate along with the sleeve 294 and motor shaft. The collar 294 includes a channel 296. The channel 296 receives an arm extending from the limit switch 286, such that the motor 284 causes the collar 294 to rotate in a first direction such that the channel 296 moves the limit switch 286 to a first position. The limit switch being in the first position can provide a wheel status signal to the programmable logic controller.

Similarly, if the motor rotates in the opposite direction, the collar 294 rotates in a second direction causing the channel 296 to move the limit switch 286 to a second position indicating a full lock mode. Accordingly, the limit switch being in the second position can provide another wheel status signal to the programmable logic controller indicating the wheel is fully locked. Alternatively, when the switch 286 is between the first and second positions the switch may for example, provide an open contact indicating that the wheel is in a free motion mode and the wheel is neither swivel locked or fully locked.

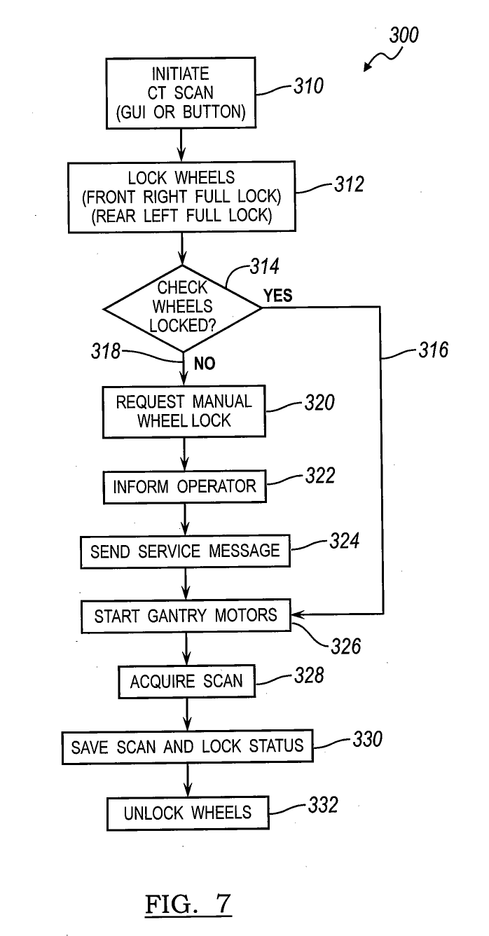

Now referring to FIG. 7, a flow chart illustrating a method 300 for locking the wheels of a medical imaging device is provided. The method 300 starts in block 310, where a scan, such as a computed tomography scan is initiated. The scan may be initiated through a physical button on a machine or a graphical user interface. In block 312, the system controller activates one or more wheel lock mechanisms. In one exemplary embodiment, the system fully locks the rear left wheel and the front right wheel to prevent movement of the system during the scanning process. In block 314, the system determines whether the wheels are locked. The system may determine that the wheels are locked based on a status flag in the controller indicating that the wheel lock mechanisms have been activated or alternatively, may check a sensor, such as a switch, in the wheel lock mechanisms to determine if the wheel has physically been locked.

If the system determines the wheels are locked, the method 300 proceeds along line 316 to block 326. If the system determines the wheels are not locked, the method 300 follows line 318 to block 320. In block 320, a system may request the operator to manually lock the wheels. In addition, the system may inform the operator that the wheels are not locked, as denoted in block 322. The system may also be connected to a network, for example the Internet over a wired or wireless connection, to send a service message indicating that the wheel locking mechanism has malfunctioned, as denoted by block 324. The message may indicate information including but not limited to the time, the date, system identification, the lock mechanism that malfunctioned, and the type of malfunction.

In block 326, the system may enable and start the gantry motors to manipulate the system into various poses required to produce a scan. The system acquires the scans, as denoted by block to 328. In block 330, the system saves the scan data and may also save the status of the wheel lock mechanisms. Saving the status of the wheel lock mechanisms may provide for better analysis of unexpected perturbations the data. The method 300 ends in block 332, where the wheel lock mechanisms are deactivated.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

I/We claim:

1. A system for performing medical imaging in a mobile environment, the system comprising:
a sensing array configured to image a subject;
a controller in communication with the sensing array to control and process acquisition by the sensing array; and
a base having at least one wheel to facilitate movement of the system, the sensing array device being connected to the base, a first wheel lock configured to prevent motion of a first wheel of the at least one wheel when the first wheel lock is activated by the controller.

2. The system according to claim 1, wherein the first wheel lock is a swivel lock.

3. The system according to claim 1, wherein the first wheel lock prevents the first wheel from rolling.

4. The system according to claim 1, further comprising a user interface in communication with the controller and configured to display information to the user, the user interface being configured to alert the user when the controller activates the first wheel lock but a sensor indicates that the first wheel is not locked.

5. The system according to claim 1, wherein the system is operable in a transportation mode where the first wheel lock is a swivel lock.

6. The system according to claim 5, wherein the system defaults to the transportation mode when the system is powered off.

7. The system according to claim 1, wherein the system is operable in a free motion mode where the first wheel lock is deactivated.

8. The system according to claim 7, wherein the system defaults to the free motion mode when the system is powered on.

9. The system according to claim 7, wherein the system defaults to the free motion mode when an alignment tool is activated.

10. The system according to claim 1, wherein the system is operable in an acquisition mode where the first wheel lock is a swivel lock and is configured to prevent swiveling of the first wheel, further comprising a second wheel lock that is a roll lock and is configured to prevent rotation of a second wheel in the acquisition mode.

11. The system according to claim 1, wherein the system is operable in an acquisition mode where the first wheel lock prevents both swiveling and rolling of the first wheel, further comprising a second wheel lock that prevents swiveling and rolling of a second wheel in the acquisition mode.

12. The system according to claim 10, wherein the system automatically switches to the acquisition mode when an acquisition is initiated.

13. The system according to claim 1, further comprising a motion device in communication with the controller to receive control commands, an x-ray source and sensing array being mounted to the motion device in a fixed relative position, the motion device being connected to the base.

14. The system according to claim 13, wherein the motion device includes a linear gantry to align the x-ray source and sensing array relative to the object.

15. The system according to claim 13, wherein the motion device includes a rotational gantry to rotate the x-ray source and sensing array around the object.

16. The system according to claim 13, further comprising a sensor configured to determine when the wheel lock is engaged, the sensor being in communication with the controller to provide a signal indicating that the wheel lock is engaged, the controller being configured to prevent movement of the motion device based on the signal.

17. The system according to claim 1, further comprising a sensor configured to determine when the wheel lock is engaged, the sensor being in communication with the controller to provide a signal indicating that the wheel lock is engaged, the controller being configured to prevent acquisition of the sensing array based on the signal.

18. A method for performing medical imaging in a mobile environment, the system comprising:
providing a sensing array configured to image a subject;
controlling and processing acquisition by the sensing array using a controller; and
activating a wheel lock to prevent motion of at least one wheel on a base of the system.

19. The method according to claim 18, further comprising preventing swiveling of the at least one wheel.

20. The method according to claim 18, further comprising preventing rolling of the at least one wheel.

21. The method according to claim 18, further comprising alerting a user when the wheel lock is activated but the at least one wheel is not locked.

22. The method according to claim 18, wherein the first wheel lock is swivel locked when system is powered off.

23. The method according to claim 18, further comprising unlocking all wheels when the system is powered on or an alignment system is activated.

24. The method according to claim 18, wherein the system automatically prevents rolling of a first wheel and swiveling of a second wheel when an acquisition is activated.
